(19) United States
(12) Patent Application Publication
(10) Pub. No.: US 2026/0288497 A1
(43) Pub. Date: Sep. 24, 2026

(54) MANAGEMENT OF ENTITY ACTIVITY IN AN INTERACTIVE PLATFORM

(71) Applicant: DevRev, Inc., Palo Alto, CA (US)

(72) Inventors: Nikhil Talwar, Bengaluru (IN); Rohith Varma Buddaraju, Chennai (IN); Anshu Avinash, Bengaluru (IN); Ritesh Goru, Bengaluru (IN); Umang Malik, Ghaziabad (IN)

(73) Assignee: DevRev, Inc., Palo Alto, CA (US)

(21) Appl. No.: 19/087,422

(22) Filed: Mar. 21, 2025

(51) Int. Cl. G06F 9/451; G06F 9/54; G06F 40/169

(52) U.S. Cl. CPC G06F 9/452; G06F 9/542; G06F 40/169

(57) ABSTRACT

Techniques for managing entity activity in interactive platforms through processing of session replay files are disclosed. The system receives an assessment request for an event, extracts an electronic page and a snippet surrounding an interacted element, and generates an annotated screenshot. A computational model analyses the annotated screenshot and the snippet to produce instrumentation data, including event attributes and identifiers. The instrumentation data is stored for future use, enabling efficient processing of similar events in subsequent sessions. The system employs validation mechanisms to ensure accurate event identification and can re-execute the model to generate modified identifiers, if needed. The system increases the efficiency and accuracy of session replay analysis, reducing manual effort and enabling more comprehensive understanding of user journeys. The present subject matter offers a scalable solution for processing large volumes of session replay data in web applications.

### TECHNICAL FIELD

The subject matter of the present invention relates to the management of activity associated with an entity. The subject matter described herein, in general, relates to analyzing and instrumenting session replay events associated with the entity in an interactive platform.

### BACKGROUND

Session replay technology has become an essential tool in the digital landscape, enabling organizations to gain valuable insights into the behavior and engagement patterns of an entity. Session replay systems typically record and re-create an entity's interaction with an interactive platform. In an example, various tracking mechanisms may be employed to capture a wide range of entity actions, including page views, clicks, mouse movements, scrolls, time spent on pages, and conversion events. Session replay systems provide organizations with crucial insights about their online presence, helping them to understand entity preferences, optimize content, and improve overall entity experience. The insights drive data-informed decision-making in areas such as marketing strategy, product development, and customer service.

### BRIEF DESCRIPTION OF DRAWINGS

A detailed description is provided with reference to the accompanying figures. In the figures, the left-most digit(s) of a reference number identifies the figure in which the reference number first appears. The same numbers are used throughout the drawings to reference features and components.

FIG. 1 illustrates a system for management of entity activity in an interactive platform, in accordance with an example of the present subject matter;

FIG. 2 illustrates a system for management of entity activity in an interactive platform, in accordance with another example of the present subject matter;

FIG. 3 illustrates a block diagram of a computing system suitable for implementing an embodiment of the present subject matter.

FIG. 4 illustrates a block diagram of a method for management of entity activity in an interactive platform, in accordance with an example implementation of the present subject matter;

FIG. 5 illustrates a non-transitory computer-readable medium for management of entity activity in an interactive platform, in accordance with an example of the present subject matter.

Throughout the drawings, identical reference numbers designate similar, but not necessarily identical, elements. The drawings provide examples and/or implementations consistent with the description; however, the description is not limited to the examples and/or implementations provided in the drawings.

### DETAILED DESCRIPTION

In modern connected computing environments, an entity may interact with multiple interactive platforms, such as a website, an application, and an online platform, for different purposes. Entities, for example, users, databases, software applications, platforms, servers, client devices, computing systems, and other resources or devices may interact with an interactive platform for different purposes and to perform different tasks. The data collected through session replay typically includes a series of events that represent various user interactions with the interactive platform. For instance, the events may be recorded along with the corresponding changes in a HTML structure of an electronic page, creating a comprehensive log of the user's experience. Further, the events associated with user interactions may also be instrumented. In an example, instrumentation, in the context of session replay, may refer to the process of adding metadata or contextual information to the recorded events. The additional layer of instrumentation information may enhance the raw data, making it more interpretable and valuable for analysis. For example, an effective instrumentation may significantly improve the quality of insights derived from session replay data, enabling more accurate understanding of user behaviors and intentions.

Conventional entity activity management systems for session replay analysis typically involve capturing and recording user interactions on websites or applications. The entity activity management system track events such as mouse movements, clicks, scrolls, and keyboard inputs, along with changes in the Document Object Model (DOM) structure. The recorded data are then stored as a session replay file, which can be played back later for analysis. Many conventional techniques provide basic visualization tools that allow analysts to view the replayed sessions, often with the ability to pause, rewind, or fast-forward through the recorded interactions.

Conventional entity activity management systems generally offer features for tagging and categorizing sessions based on predefined criteria, such as user demographics, device types, or specific interaction patterns. In an example, the entity activity management systems may be integrated with analytics platforms to correlate session replay data with other metrics such as conversion rates or time-on-page. Manual instrumentation is often a key component of conventional entity activity management systems, allowing developers to add custom event tracking for specific elements or interactions of interest.

However, recording, instrumenting, and analyzing the session replay events may experience several challenges. Conventional systems often struggle with the high volume of data generated by user interactions. As interactive platforms, such as websites and applications become more complex and interactive, the amount of data captured during a single session can be very high, thereby leading to challenges in storage, processing, and analysis, thus causing delays in insights generation and increased costs for businesses. The conventional entity activity management systems lack auto-instrumentation capabilities. The conventional techniques typically require manual configuration and tagging of elements to track specific interactions, which can be time-consuming, error-prone, and inflexible. Further, as web applications grow more complex and dynamic, manual instrumentation struggles to keep pace with rapidly changing user interfaces and interaction patterns. This may result in incomplete or inaccurate data collection, missing important user behaviors and failing to provide a comprehensive view of the user journey.

In addition, the raw data captured by conventional session replay tools often lacks crucial context, making it difficult to derive meaningful insights. While the conventional approaches can record basic interactions like clicks and keystrokes, they frequently fail to capture the full context illustrating why a user performed a particular action or the significance of the performed action within the broader user experience. Such contextual gap may limit the ability of analysts and developers to truly understand user behavior, identify valuable insights, and make informed decisions about product improvements. Furthermore, the high volume of data generated by session replays may have no efficient way to filter out noise and focus on the most relevant interactions.

Further, session replay files are extremely large as the files include detailed information about every aspect of interaction of a user with the interactive platform. Conventional approaches often lack the computational power or technique required to quickly extract meaningful patterns or insights from the session replay data. This can lead to significant delays in generating actionable intelligence, reducing the value of the collected data and hindering rapid iteration and improvement cycles. Moreover, the storage and processing requirements for such large datasets can be prohibitively expensive, especially for organizations dealing with high traffic volumes.

The present subject matter envisages techniques for managing entity activity, in particular, instrumenting and analyzing user interactions within interactive platforms through the processing of session replay files. The present subject matter employs advanced computational techniques to extract meaningful insights from user behavior, ultimately enhancing the understanding of user journeys and improving the overall user experience.

According to one example, an entity may access an interactive platform, such as a website or an application and provide assessment requests for specific events captured within session replay files. The session replay files are comprehensive records of user interactions with an interactive platform, including information of data about how users navigate, engage with, and respond to various elements of a digital interface. In an example, the session replay file includes multiple events representing interactions of the entity with the interactive platform. The assessment requests serve as a trigger for the system to delve into the intricacies of the user interactions, aiming to interpret and derive valuable insights from user behavior.

In an example implementation, upon receiving an assessment request, analysis of the event may be initiated. The initial step involves extraction of two key pieces of information: an electronic page representing state of the interactive platform at a particular moment of the event, and a snippet of the electronic page focusing on a specific element with which the user interacted. The extraction process assists in contextualizing the event within the broader user experience.

In an example, the extraction of electronic page includes capturing a snapshot of the entire interface as it appeared to the user at the time of the interaction. The comprehensive view of the electronic page helps in understanding the overall context in which the event occurred. The electronic page may include elements such as the layout, content, and visual design of the page, all of which can influence user behavior and decision-making. In an example implementation, the snippet, surrounding the element of interaction, provides a detailed look at the immediate area of user engagement, offering insights into the specific features, content, or design elements that prompted the user's action. By capturing both the macro and micro views of the interaction, the present subject matter ensures a holistic understanding of the event context.

Following the extraction phase, an annotated screenshot of the interactive platform may be generated for the event. The annotated screenshot serves as a visual representation of the user's interaction, highlighting the specific element involved within the context of the entire page. The annotation process involves overlaying visual markers or indicators on the screenshot to draw attention to the area of interaction, making it easy for analysts or automated systems to quickly identify and understand the nature of the event. The generation of the annotated screenshot bridges the gap between raw data and visual interpretation. The annotated screenshot allows for a more intuitive understanding of the user's experience, providing clear visual context that may be effective in identifying patterns, issues, or opportunities for improvement in the user interface or user experience design.

After obtaining the annotated screenshot and the snippet, a computational model may be leveraged to generate instrumentation data for the event. In an example, the computational model may incorporate advanced technologies such as machine learning or artificial intelligence, to analyze the visual and structural information provided and produce detailed instrumentation data. In an example, the instrumentation data generated by the computational model may be a comprehensive set of attributes associated with the event. The attributes may include, but are not limited to event classification or categorization, user intent analysis, interaction type (e.g., click, scroll, hover), element properties (e.g., size, position, content), contextual information (e.g., page section, surrounding elements), and temporal data (e.g., time spent on element, sequence in user journey).

In an example, the set of attributes may include one or more of a name of the event, a description of the event, and an identifier designed to identify similar events in subsequent assessment requests. The set of attributes may provide a multi-dimensional view of the event, thereby offering deep insights into the user interactions.

In an example implementation, the present subject matter includes a validation mechanism to validate the identifier. The validation mechanism involves checking whether the identifier correctly identifies the element associated with the event that triggered its creation. On determining that the identifier fails to correctly identify the element, a corrective action may be taken. For instance, the corrective action may be a re-execution mechanism. In the re-execution mechanism, the computational model may be executed again with both the failed identifier and the snippet as inputs. The re-execution mechanism generates a modified identifier correctly identifying the event. The validation and correction mechanism ensures the ongoing accuracy and reliability of the event identification capabilities.

The computational model has an ability to generate the instrumentation data automatically. Such technique helps in eliminating the need for manual annotation or interpretation of events, which can be time-consuming, inconsistent, and prone to human error. Instead, the automatic generation of instrumentation data provides a standardized, objective analysis of each event, ensuring consistency and enabling large-scale processing of user interactions. In an example implementation, once the instrumentation data is generated, the instrumentation data may be stored in a database. The storage in the database may allow for the accumulation of a rich dataset of analyzed events over time, which can be used for trend analysis, pattern recognition, and longitudinal studies of user behavior. Further, the storage of the instrumentation data helps to quickly retrieve and apply previously generated instrumentation data to similar events in the future, significantly improving processing efficiency.

The stored instrumentation data may be efficiently used for handling subsequent assessment requests for the same or similar events. When a new event is encountered, the database may be quickly checked to determine if instrumentation data already exists for a matching or similar event. If a match is found, the existing stored instrumentation data can be applied, reducing the need for repeated analysis and improving response times. Such an approach of storing and reusing instrumentation data introduces a learning component to the present subject matter. As more events are processed and stored, the present subject matter becomes increasingly efficient and potentially more accurate in its assessments. The accumulated knowledge from historical analyses can be leveraged to inform and refine interpretations of new events.

In an example implementation, when a new event is received from a subsequent session replay file, the new event is compared with the previously stored snippet. Based on the comparison, it may be ascertained whether to utilize the existing instrumentation data for the new event. If the new event matches the instrumentation data associated with the original event, the existing instrumentation data may be applied to the new event. Such an approach allows for efficient processing of similar events across different session replay files, reducing the need for repeated analysis.

In an example implementation, instead of a simple match/no-match comparison, a similarity score may be computed between the new event and the extracted snippet. The similarity score may then be used to determine whether the existing instrumentation data should be applied to the new event. For instance, a predetermined threshold value may be set and if the similarity score exceeds the predetermined threshold value, then the instrumentation data may be applied to the new event. Such technique allows for a more flexible and granular approach to event comparison, thereby capturing a wider range of similar events while still maintaining accuracy.

The ability to handle subsequent assessment requests increases the efficiency of the present subject matter. By maintaining a database of instrumentation data, the present subject matter can quickly respond to queries about user behavior, provide insights for A/B testing, support user experience optimization efforts, and contribute to the continuous improvement of the interactive platform. Moreover, the present subject matter's design allows for scalability and adaptability. As the volume of user interactions grows and new types of interactions emerge, the system can continue to process and analyze events effectively. The computational model can be updated or refined over time to incorporate new analysis techniques or to adapt to changing user behaviors and interface designs.

The present subject matter's approach to event analysis in session replay files offers several significant advantages over traditional methods. By extracting both the full electronic page and a focused snippet, each event may be analyzed within its full context, leading to more accurate interpretations of user behavior. Further, the generation of annotated screenshots provides a clear, visual representation of each event, making it easier for both human analysts and automated systems to understand and interpret user interactions. The use of a computational model to generate instrumentation data automates a process that would be extremely time-consuming and potentially inconsistent if done manually. The instrumentation data may also be stored for future use, thereby ensuring that the system becomes more efficient over time, able to quickly process and categorize similar events without repeated analysis. The present subject matter is designed to handle large volumes of data, making it suitable for analyzing user behavior across extensive digital platforms with high traffic.

In addition, the computational model can be updated or refined to incorporate new analysis techniques or adapt to evolving user interfaces and behaviors. Automated analysis ensures consistent interpretation of events across all user sessions, eliminating variability that may occur with manual analysis. The rich set of attributes generated for each event allows for deep, multi-dimensional analysis of user behavior and platform performance.

The applications of the present subject matter are vast and varied. In the realm of user experience design, the present subject matter can provide invaluable insights into how users interact with different elements of a digital interface, highlighting areas of confusion, interest, or conflict. This information can drive targeted improvements to the user interface, enhancing usability and user satisfaction. For marketing and product teams, the system offers a powerful tool for understanding user journeys and preferences. By analyzing patterns of interaction across many users, the system may reveal popular pathways through a site or application, identify features that resonate with users, and uncover potential barriers to conversion or engagement. In the context of customer support and troubleshooting, the system can help identify recurring issues or trouble points in the user experience. By flagging unusual patterns of behavior or frequent points of abandonment, the present subject matter can alert teams to potential problems before they escalate, enabling proactive resolution and improvement. For developers and quality analyst's teams, the system provides a means of monitoring the real-world performance and functionality of their applications. By analyzing user interactions, it can help identify bugs, performance issues, or unexpected behaviors that may not have been caught during testing. In the field of digital analytics, the system represents a significant advancement. Traditional analytics often rely on predefined events or page views, which can miss the nuances of user behavior. The present subject matter's ability to capture and analyze detailed interactions provides a much richer dataset for analysis, enabling more sophisticated modeling of user behavior and more accurate predictions of future trends.

The present subject matter also has potential applications in the realm of personalization and user targeting. By understanding individual user behaviors and preferences through detailed event analysis, platforms could potentially offer more tailored experiences, recommending content or features based on observed interaction patterns. From a compliance and user privacy perspective, the system's ability to process and interpret user interactions automatically, without direct human intervention, could offer advantages in terms of data protection and confidentiality. By focusing on patterns and aggregated data rather than individual user identities, it may be possible to gain valuable insights while maintaining user privacy.

The system's design also allows for continuous improvement and refinement. As more data is processed and more patterns are identified, the computational model can be updated to incorporate new insights, potentially improving its accuracy and the depth of its analysis over time. This creates a virtuous cycle where the system becomes more valuable and effective as it processes more data. Thus, by combining contextual data extraction, visual representation, automated instrumentation, and efficient data storage and retrieval, the present subject matter offers a powerful tool for understanding and optimizing user experiences in interactive platforms.

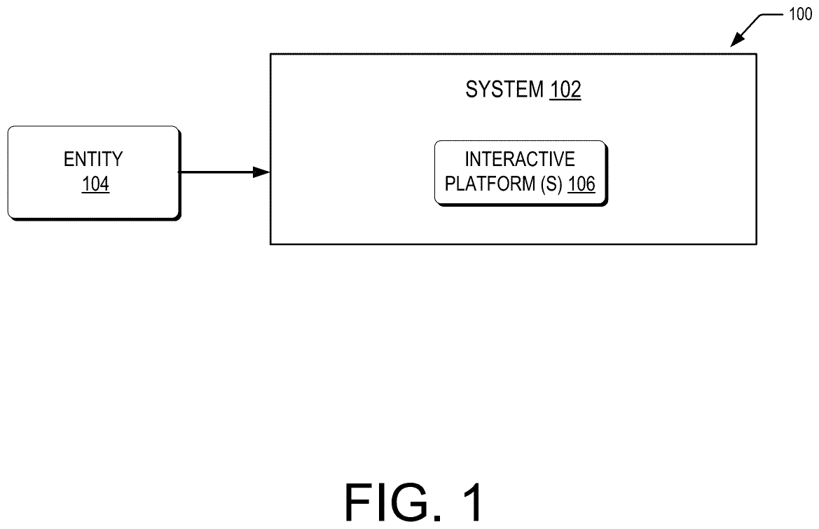

The present subject matter is further described with reference to FIGS. 1-5. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 102 for management of entity activity, according to an example implementation of the present subject matter. The system 102 may be implemented in various computing environments 100 and contexts. In an example, the system 102 may be deployed on cloud-based infrastructure, allowing for scalability and flexibility in resource allocation. The system 102 may also be implemented on on-premises servers or as a hybrid solution combining both cloud and on-premises components. In some cases, organizations may choose to implement the system 102 as a Software-as-a-Service (SaaS) solution, enabling easy access and reducing the need for in-house infrastructure management. Alternatively, larger organizations may opt for a fully customized, on-premises deployment to maintain complete control over their data and security protocols.

The system 102 may be communicatively coupled to one or more entity 104 through a network infrastructure. The one or more entity may be users, databases, software applications, platforms, servers, client devices, computing systems, and other resources or devices. In an example, the network infrastructure may include local area networks (LANs), wide area networks (WANs), cloud-based networks, or hybrid network configurations, enabling seamless communication and data transfer between the system 102 and its connected components. The system 102 may communicate with the entity 104 through various communication protocols and interfaces, such as APIs, web services, database connectors, or secure file transfer protocols. The system 102 may also be communicatively coupled to a data repository (not shown in fig.) for storing the data associated with user interaction with an interactive platform 106. The data repository may serve as the central nervous system of tracking and analysis operations, housing vast amounts of raw data that will later be processed to extract meaningful insights.

In an example, the entity 104 may access an interactive platform 106. The interactive platform 106 may include websites, web applications, or mobile applications designed to facilitate user engagement and data collection. The interactive platform 106 represents the digital interface through which entities interact with an organization's online presence, services, or products. The interactive platform 106 may be chosen based on the organization's specific needs, such as data analysis requirements, operational processes, or integration with other systems. For instance, an interactive platform 106 may be an e-commerce website, a customer support platform, a content management system, or a business intelligence dashboard. In an example, the interactive platform 106 may serve as the primary point of interaction between the entity and the interactive portal, generating user events, capturing user inputs, and displaying responses from the system.

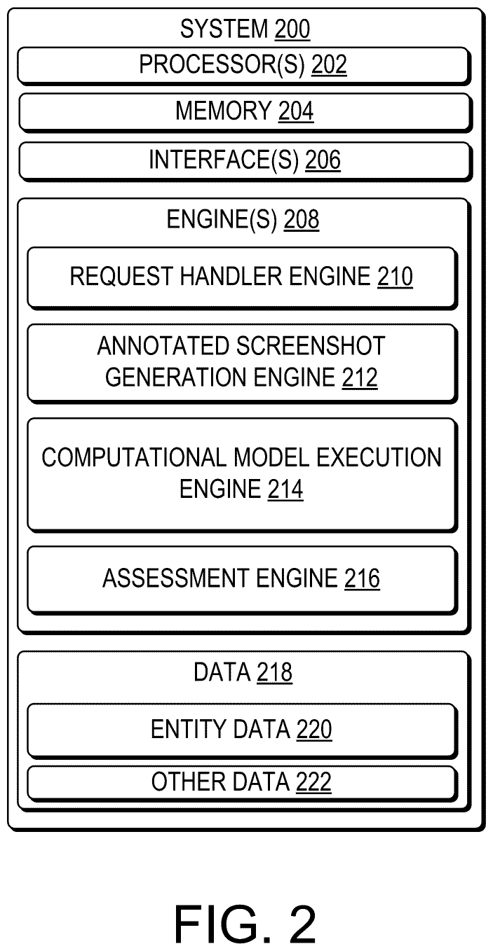

In another example, the system 102 may obtain a session replay file. The data collected through the session replay file typically includes a series of events that represent various interactions of the entity 104 with the interactive platform 106. For instance, the events may be recorded along with the corresponding changes in a HTML structure of an electronic page, creating a comprehensive log of the entity's experience. The system 102 analyses and instruments the entity activity data generated through interactions through the processing of session replay files, as explained in detail with respect to FIG. 2.

FIG. 2 illustrates a system 200 for management of entity activity, in particular, for instrumenting and analyzing user interactions with interactive platforms through the processing of session replay files, according to an example implementation of the present subject matter. The system 200 may include a computing device that has processing capabilities, such as a server, a desktop, a laptop, a tablet, a mobile phone, or the like. For instance, the system 200 may include, for example, a microprocessor, a microcomputer, a microcontroller, a digital signal processor, a central processing unit, a state machine, a logic circuitry, or a device that manipulates signals based on operational instructions. The system 200 may correspond to the system 102. The system 200 may include a processor 202, a memory 204, and an interface(s) 206.

The processor 202 may run at least one operating system and other applications and services. Further, the processor 202 can include one or more engines 208. The processor 202, amongst other capabilities, may be configured to fetch and execute computer-readable instructions stored in the memory 204. The processor 202 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labelled as “processor”, may be provided through the use of dedicated hardware as well as hardware capable of executing machine readable instructions.

When provided by the processor 202, the functions may be provided by a single dedicated processor, by a single shared processor, or by a plurality of individual processors, some of which may be shared. Moreover, explicit use of the term “processor” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. Other hardware, conventional and/or custom, may also be included.

The memory 204 may be coupled to the processor 202 and may, among other capabilities, provide data and instructions for generating different requests. The memory can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory 204 may include data 218, such as an entity data 220 and other data 222, that can be commissioned for management of entity activity.

The interface(s) 206 may include a variety of machine-readable instructions-based interfaces and hardware interfaces that allow the system 200 to interact with different entities, such as the processor 202 and the memory 204. Further, the interface may enable the components of the system 200 to communicate with computing devices, web servers, and external repositories. The interface may facilitate multiple communications within a wide variety of networks and protocol types, including wireless networks, wireless Local Area Network (WLAN), RAN, satellite-based network, and the like.

The engines 208 may include routines, programs, objects, components, data structures, and the like, which perform particular tasks or implement particular abstract data types. The engines 208 may further include modules that supplement applications on the system 200, for example, modules of an operating system. Further, the engines 208 may be implemented in hardware, instructions executed by a processor, or by a combination thereof.

In an implementation, the engines 208 may be machine-readable instructions which, when executed by the processor 202, perform any of the described functionalities. The machine-readable instructions may be stored on an electronic memory device, hard disk, optical disk or other machine-readable storage medium or non-transitory medium. In one implementation, the machine-readable instructions can also be downloaded to the storage medium via a network connection.

The engine 208 may perform different functionalities. The engines 208 include a request handler engine 210, an annotated screenshot generation engine 212, a computational model execution engine 214, and an assessment engine 216. The functions of the engines 210, 212, 214, and 216 are explained below.

In an example, the request handler engine 210 may receive an assessment request from an entity. For instance, the entity may be a user, database, software application, platform, server, client device, computing system, and other resource or device. The assessment request may be specifically tied to an event that is part of a session replay file. The session replay file is a comprehensive capture of the entire journey of the entity through an interactive platform. For example, the session replay file may be a data source that contains a chronological sequence of events, each representing a distinct interaction between the entity, such as a user, and the interactive platform.

The interactions can encompass a wide range of user actions, such as mouse movements, clicks, keyboard inputs, form submissions, page navigations, and even more complex behaviors like hovering over elements or interacting with dynamic content. Each of the events may be recorded with a timestamp, precise timing, and contextual information, allowing for a detailed reconstruction of the user's experience.

In an example implementation, the assessment request may be initiated by the entity to interpret the interactions of the entity with the interactive platform. The system 200 may analyze and derive information from the recorded interactions. In one example, the interpretation process may use advanced algorithms, including machine learning or artificial intelligence techniques, to extract patterns, identify user intentions, and understand the user's journey through the interactive platform. The interpretation of the interactions may serve multiple purposes. From a user experience perspective, the interpretation may help to identify error points, areas of confusion, or particularly engaging elements within the platform. For business purposes, the interpretation may reveal insights into user preferences, decision-making processes, or conversion patterns. From a technical standpoint, the interpretation may help in identifying performance issues, bugs, or areas where the platform's functionality can be improved.

In an example implementation, when an assessment request is received, the request handler engine 210 initiates the extraction of an electronic page. The extracted electronic page corresponds to a state of the interactive platform at the time of the event. For example, the electronic page may represent a snapshot of the entire interface, including page's structure, content, and state, as it appeared to the user at the precise moment of the interaction being analyzed.

The extracted electronic page may provide the full context in which the user interaction occurred and may capture all elements visible to the user, including text, images, buttons, forms, and any dynamic content present at that specific moment. The comprehensive view of the electronic page helps in understanding the user's environment and the options available to the user while performing the action. In an example, for extracting the electronic page, the request handler engine 210 may reconstruct the electronic page from the session replay data. The reconstruction may involve applying CSS styles and any other elements that contribute to the electronic page's appearance and functionality.

In another example implementation, when an assessment request is received, the request handler engine 210 initiates the extraction of a snippet of the electronic page. The snippet of the electronic page surrounds an element associated with the entity interaction. The snippet may be a focused extract of the electronic page, indicating the specific area where the user interaction took place. The extraction of the snippet is a more targeted and granular approach compared to capturing the entire electronic page. The snippet isolates the relevant portion of the page directly related to the user's action. For example, if a user clicked a button, the snippet may include the button itself, its immediate container, and a small area around it to provide immediate context.

In an example, for extracting the snippet, the request handler engine 210 may identify the element with which the user interacted and determine an appropriate scope for the snippet. The determination of the scope may include deciding the extent of the surrounding content to include in the snippet to understand the interaction without including extraneous information. In an example, the HTML, CSS, and JavaScript code defining the snippet may also be extracted to ensure that the extracted portion may be accurately rendered and analyzed for subsequent assessment requests. The request handler engine 210 may also preserve any relevant state information for interactive elements within the snippet. For instance, if the interaction involves a form field, the snippet may capture the state of the form field (e.g., its contents, validation state) at the time of the interaction.

In an example implementation, when an assessment request is received, the request handler engine 210 initiates the extraction of both the electronic page and the snippet of the electronic page. The combination of the full electronic page and the focused snippet may provide a powerful tool for analysis. The full page may offer a macro view, allowing analysts to understand the overall context and environment in which the interaction occurred. The snippet, on the other hand, may provide a micro view, focusing attention on the specific elements directly involved in the interaction.

In an example, the request handler engine 210 may identify the timestamp at which the interactions of the entity with the interactive platform may occur in the session replay file. For instance, the timestamps may be recorded in a standardized format. The timestamps may help in calculating important metrics such as time spent on specific pages, duration between clicks, and overall session length. The metrics may provide valuable insights into user engagement, efficiency of the user interface, and areas for improvement in the application's design or functionality. The identification of timestamps also helps in synchronizing the events recorded in the session replay file with other data sources. For example, the timestamps may allow the system to correlate user actions with server-side logs, analytics data, or other time-stamped events. The synchronization can provide a more comprehensive view of the user's experience, including factors that may not be directly visible in the client-side replay, such as server response times or background processes.

In an example implementation, the annotated screenshot generation engine 212 generates an annotated screenshot of the interactive platform for the event. The annotated screenshot is generated based on the extracted electronic page and the snippet. To create the annotated screenshot, the annotated screenshot generation engine 212 may first render the electronic page in a controlled environment, essentially recreating the visual state of the interactive platform as it appeared to the user at the time of interaction. For instance, the rendering process may include interpreting the HTML, CSS, and JavaScript of the electronic page to produce an accurate visual representation. Once the electronic page is rendered, the annotated screenshot generation engine 212 may capture a high-resolution screenshot of the entire visible area. The captured screenshot may serve as a base canvas upon which annotations may be added.

The annotated screenshot generation engine 212 may then identify the precise location of the element associated with the entity interaction within the screenshot. In an example, to identify the precise location, the snippet may be analyzed to extract key identifiers, such as element IDs, classes, or unique attributes that can be used to locate the corresponding element within the electronic page screenshot. In an example, advanced image processing and computer vision techniques may be employed to accurately pinpoint the element's position or location, considering factors such as scroll position, dynamic content loading, and responsive design elements that may affect the element's location. With the target element located, the system may proceed to overlay visual markers or annotations on the screenshot to highlight the interacted element.

The annotations may be designed to draw attention to the specific area of interaction while maintaining clarity and context within the overall electronic page view. The visual markers may take various forms, depending on the nature of the interaction and the system's design preferences. For example, annotation styles may include, but not limited to, colored outlines or borders around the element, semi-transparent highlight overlays, arrows or pointers directing attention to the element, magnified insets or zoomed views of the interaction area, and numbered or labeled markers for sequential interactions. The choice of annotation style may balance visibility with non-intrusiveness, ensuring that the highlighted element stands out without obscuring important surrounding context. In addition to highlighting the specific element, the annotated screenshot generation engine 212 may incorporate contextual annotations to provide additional information about the event. The contextual annotations may include, but not limited to, event type labels (e.g., “Click”, “Hover”, “Input”), timestamps indicating when the interaction occurred, brief descriptions of the action performed, user identifiers or session information, and custom tags or categories assigned to the event.

In an example implementation, on receiving the annotated screenshot and the snippet, the computational model execution engine 214 may execute a computational model to generate instrumentation data for the event. In an example, the computational model may be a Large Language Model (LLM), a computer vision model, or a combination of the Large Language Model (LLM) and the computer vision model. The LLM may be designed to understand and generate human-like text, while the computer vision model may be specialized in interpreting visual information from images. By combining these two types of models, the computational model execution engine 214 may process both textual and visual inputs to generate comprehensive instrumentation data.

When the computational model receives the annotated screenshot and the snippet, such as a HTML snippet, the computational model analyzes the visual information in the screenshot. The computer vision component of the computational model may identify key elements within the image, such as buttons, text fields, icons, and other interactive elements. The computer vision component may also interpret the annotations on the screenshot, which highlight the specific element associated with the user interaction. The visual analysis may provide context about the layout and design of the user interface at the time of the event. Simultaneously, the LLM component of the computational model may process the HTML snippet. The snippet includes the structured code representation of the part of the electronic page where the interaction occurred. The LLM may also understand the hierarchical structure of the HTML, the classes and IDs assigned to elements, and any text content within the snippet. The textual analysis complements the visual information, thus providing a more complete picture of the interaction context.

In an example, the computational model may then correlate the visual information from the screenshot with the structural information from the HTML snippet for generating accurate and useful instrumentation data. The instrumentation data may be indicative of one or more attributes associated with the event. The one or more attributes include a name of the event, a description of the event, and an identifier designed to identify similar events in the subsequent assessment request. In an example, the computational model may assign a descriptive name to the event, such as “clickPriorityP0” for a click on a priority label. The name may be derived from the model's understanding of the action performed and the element interacted with. In another example, the computational model may generate a human-readable description of the event, explaining the action performed and the element on which the action has been performed. For instance, “This event is triggered when the user clicks on the ‘P0’ priority label in the attributes section of an issue.”

In yet another example, the computational model may generate an identifier, such as a JavaScript code that may be used to identify similar events in future sessions. The code may be designed to uniquely identify the element that was interacted with, based on its attributes, position in the DOM, or other characteristics. In addition, the instrumentation data may include other relevant information about the event. The other relevant information may include, but not limited to, the type of interaction (click, hover, input, etc.), state of the element before and after the interaction, data associated with the element (e.g., the text content of a button), position of the element on the page, and timing of the event within the overall session. The computational model's ability to generate the instrumentation data may be based on its training on vast amounts of web interaction data.

The instrumentation data may provide insights into user behavior that would be extremely time-consuming and error-prone to generate manually. The usage of an AI model for generation of instrumentation data helps in adapting to a wide variety of user interfaces and interaction patterns. Traditional methods of instrumenting web applications requires developers to manually add tracking code to specific elements. This transitional approach is not only time-consuming but also brittle, as it can break when the user interface is updated. In contrast, the AI model can automatically adapt to changes in the UI, as long as the fundamental purpose and context of the elements remain similar.

The assessment engine 216 may then store the instrumentation data in a database. The instrumentation data, produced by the computational model based on the annotated screenshot and HTML snippet of an event, contains valuable information about the user interaction. The instrumentation data may include attributes such as the event name, a description of the event, and a unique identifier designed to recognize similar events in future sessions.

In an example implementation, the unique identifier may be validated for the event before it is stored as the instrumentation data in the database. The validation mechanism for the identifier may ensuring the accuracy and reliability of the identifier in identifying the correct elements associated with specific events. For validation, the system 200 may determine whether the identifier fails to correctly identify the element associated with the event. The process may involve applying the identifier to the original event data and comparing the result with the known correct element. If there's a mismatch or if the identifier fails to pinpoint the exact element that was interacted with during the event, it may be flagged as a failure. In an example, when a failure is detected, the system 200 does not discard the identifier or mark the event as unprocessable, instead the system 200 executes the computational model again with the failed identifier and the snippet of the electronic page surrounding the element associated with the event. The computational model may then analyze the failed identifier and may use the analysis to generate a modified identifier, wherein the modified identifier may correctly identify the event.

In an example implementation, the instrumentation data may be stored to create a repository of pre-processed and analyzed events. For example, the repository may serve as a knowledge base that the system 200 can quickly access and utilize when processing future or subsequent events, significantly enhancing the efficiency and speed of subsequent analyses.

In an example implementation, when a new session replay file is processed, the assessment engine 216 may first check the database to determine if it contains instrumentation data for similar events. In one example, when a new event is received from a subsequent session replay file, the assessment engine 216 may initiate a comparative analysis between the new event and the one or more attributes associated with the event. For instance, the assessment engine 216 may initiate a comparative analysis between the new event and the identifier associated with the event. The system 200 may use pattern matching techniques to identify structural and contextual similarities between the new event and the one or more attributes. In scenarios, when a match is found based on the comparative analysis, the assessment engine 216 may reuse the existing instrumentation data instead of generating it a new instrumentation data. The matching criteria for determining when to apply existing instrumentation data to the new event may be carefully calibrated.

In another example, when a subsequent assessment request is received for a new event corresponding to a subsequent session replay file, the assessment engine 216 may initiate a comparative analysis between the new event and the previously stored snippet. The system 200 may then determine a similarity score to identify structural and contextual similarities between the new event and the stored snippet. In scenarios, when a high degree of similarity is found, the assessment engine 216 may reuse the existing instrumentation data instead of generating it a new instrumentation data. The matching criteria for determining when to apply existing instrumentation data to the new event may be carefully calibrated. For instance, the matching criteria may include thresholds for similarity scores, specific patterns in the HTML structure, or a combination of multiple factors. The system 200 may also employ machine learning techniques to refine the matching criteria over time, improving the ability of the system 200 to accurately identify similar events.

By reusing existing instrumentation data, the system 200 can bypass the computationally intensive step of running the computational model for every event, thereby reducing the processing time for session replays, especially as the database grows and more events are pre-processed. Reusing instrumentation data not only optimizes resource usage but also ensures that similar events across different session replays are interpreted consistently for providing accurate trend analysis and user behavior understanding.

In an example implementation, the system 200 may have advanced analytical capabilities. The system 200 may analyze the instrumentation data generated for multiple events within a session replay file. Further, the system 200 may identify relationships between the multiple events based on the analyzed instrumentation data. The identified relationships may help in generating an entity journey map. In an example, the entity journey map may provide a visual or conceptual representation of the interaction of the entity (typically a user) with the interactive platform over time, thereby illustrating the sequence and connections between different events. The system 200 may then provide representations of the entity journey map, which may be in various forms such as visual diagrams, interactive displays, or structured data outputs. The representation allows for a higher-level understanding of user behavior and interaction patterns, moving beyond individual events to capture the overall user experience and journey through the interactive platform.

The present subject matter offers several significant advantages. The system provides a comprehensive and automated approach to analyze user interactions within interactive platforms. By processing session replay files using advanced computational techniques, the present subject matter extracts meaningful insights from user behavior that would be extremely time-consuming and error-prone to generate manually. The system's ability to capture both macro and micro views of user interactions, through the extraction of full electronic pages and focused snippets, allows for an efficient understanding of user experiences. The depth of analysis enables organizations to identify usability issues, optimize user interfaces, and enhance overall user satisfaction across various devices and platforms.

The system's use of the computational model to generate instrumentation data increases the efficiency and adaptability of the instrumentation and analysis technique. Unlike traditional methods that require manual tagging and configuration, this approach automatically adapts to changes in user interfaces and interaction patterns. The system's ability to store and reuse instrumentation data for similar events further enhances its efficiency, reducing processing time and ensuring consistent interpretation of user behaviors across multiple sessions and platforms. Thus, the comprehensive approach to entity management leads to improved user experiences, more effective marketing strategies, and better achievement of organizational objectives.

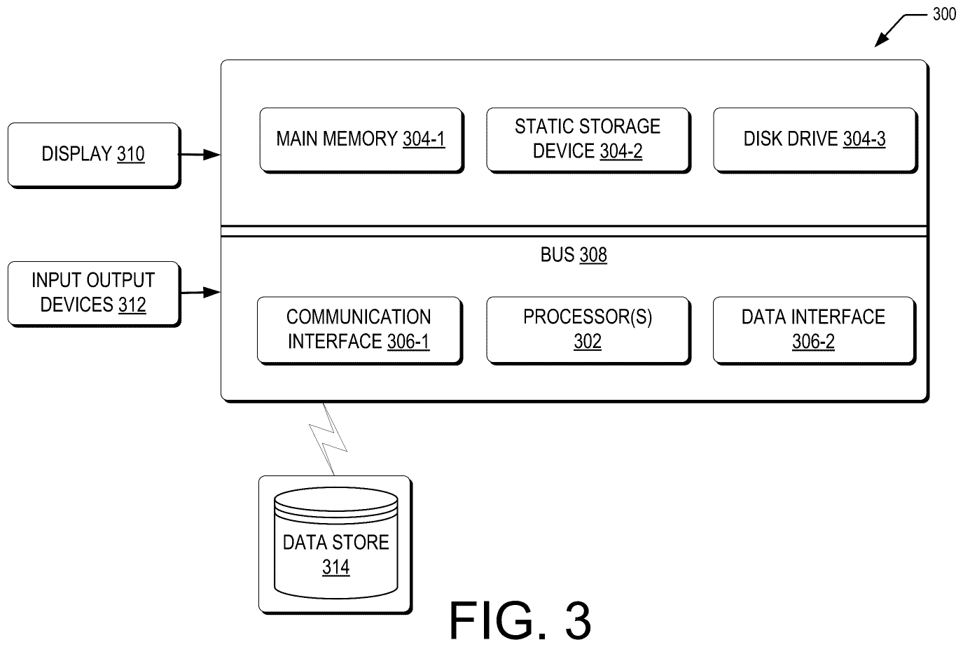

FIG. 3 illustrates a block diagram of a computing system 300 suitable for implementing an embodiment of the present subject matter. Computing system 300 may include a bus 308 or other communication mechanism for communicating information, which interconnects subsystems and devices, such as processor(s) 302, main memory 304-1 (e.g., RAM), static storage device 304-2 (e.g., ROM), disk drive 304-3 (e.g., magnetic or optical), communication interface 306-1 (e.g., modem or Ethernet card), display 310 (e.g., CRT or LCD), input device 312 (e.g., keyboard, and cursor control).

According to one embodiment of the present subject matter, the computing system 300 performs specific operations by the processor(s) 302 executing one or more sequences of one or more instructions contained in the main memory 304-1. Such instructions may be read into the main memory 304-1 from another computer readable/usable medium, such as the static storage device 304-2 or disk drive 304-3. In alternative embodiments, hard-wired circuitry may be used in place of or in combination with software instructions to implement the invention. Thus, embodiments of the present subject matter are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to the processor(s) 302 for execution. Such a medium may take many forms, including but not limited to, non-volatile media and volatile media. Non-volatile media includes, for example, optical or magnetic disks, such as disk drive 304-3. Volatile media includes dynamic memory, such as main memory 304-1. A data store 314 may be accessed in a computer readable medium using a data interface 306-2.

Common forms of computer readable media includes, for example, a floppy disk, a flexible disk, a hard disk, a magnetic tape, any other magnetic medium, a CD-ROM, any other optical medium, punch cards, a paper tape, any other physical medium with patterns of holes, RAM, PROM, EPROM, FLASH-EPROM, any other memory chip or cartridge, or any other medium from which a computer can read.

In an embodiment of the present subject matter, execution of the sequences of instructions to practice the present subject matter is performed by a single computing system 300. According to other embodiments of the present subject matter, two or more computing systems 300 coupled by communication link (e.g., LAN, PTSN, or wireless network) may perform the sequence of instructions required to practice the invention in coordination with one another.

The computing system 300 may transmit and receive messages, data, and instructions, including program, i.e., application code, through communication link and communication interface 306-1. Received program code may be executed by the processor(s) 302 as it is received, and/or stored in the disk drive 304-3, or other non-volatile storage for later execution.

In a typical configuration, the computer includes one or more processors (CPU), an input/output interface, a network interface, and a memory. The memory can consist of a non-persistent memory, a random-access memory (RAM), and/or a non-volatile memory in a computer-readable medium, for example, a read-only memory (ROM) or a flash memory (flash RAM). Memory is an example of a computer-readable medium.

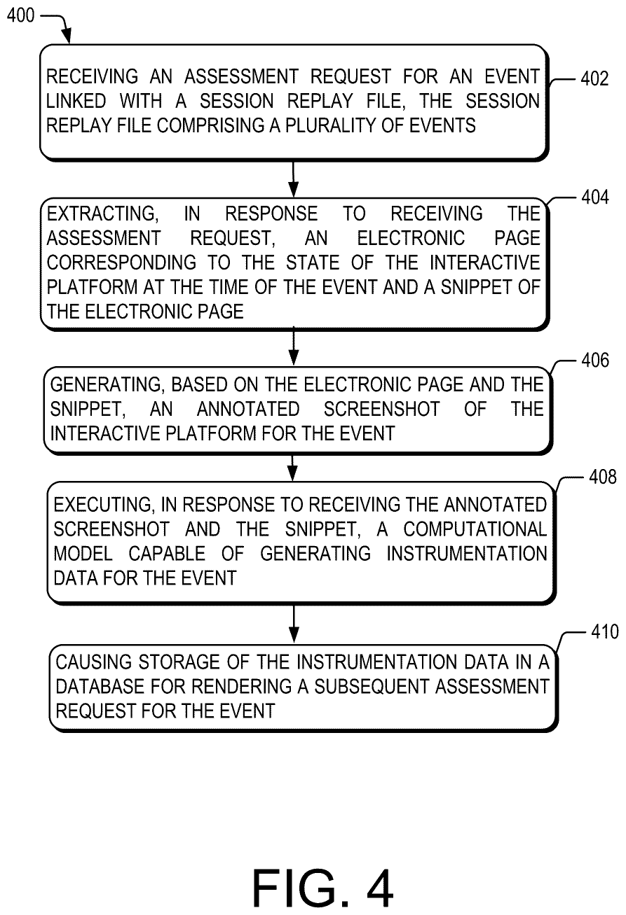

FIG. 4 illustrates a block diagram of a method for management of entity activity, in accordance with an example implementation of the present subject matter. Although the method 400 may be implemented in a variety of devices, but for the ease of explanation, the description of the method 400 is provided in reference to the above-described system 102 and 200. The order in which the method 400 is described is not intended to be construed as a limitation, and any number of the described method blocks may be combined in any order to implement the method 400, or an alternative method.

It may be understood that blocks of the method 400 may be performed in the system 102 and 200. The blocks of the method 400 may be executed based on instructions stored in a non-transitory computer-readable medium, as will be readily understood. The non-transitory computer-readable medium may comprise, for example, digital memories, magnetic storage media, such as magnetic disks and magnetic tapes, hard drives, or optically readable digital data storage media.

At block 402, the method includes receiving an assessment request for an event linked with a session replay file. The session replay file includes a plurality of events that represent interactions of an entity with an interactive platform. In an example, the event may capture various user actions such as clicks, scrolls, form inputs, and page navigations. The assessment request may interpret the interactions to gain insights into the entity's behavior and experience on the interactive platform. On receiving the request, the event may be analyzed within the context of the entire session. For example, relevant information from the session replay file may be obtained including the state of the interactive platform at the time of the event and the specific element with which the entity interacted. This step initiates the process of deep analysis and instrumentation of the user's journey through the interactive platform.

At block 404, in response to receiving the assessment request, an electronic page corresponding to the state of the interactive platform at the time of the event and a snippet of the electronic page surrounding an element associated with the interaction of the entity may be extracted. This step involves capturing two key pieces of information: a full snapshot of the interactive platform's interface as it appeared to the user during the event, and a focused extract of the specific area where the interaction occurred. The electronic page provides the complete context of the user's environment, including all visible elements, layout, and content. The snippet isolates the relevant portion directly related to the user's action, such as a button click or form input. In an example, the extraction process may utilize data from the session replay file to reconstruct the exact state of the platform at the moment of interaction, ensuring a comprehensive and accurate representation of the event context.

At block 406, the method includes generating an annotated screenshot of the interactive platform for the event, based on the extracted electronic page and snippet. This step involves rendering the full electronic page as it appeared at the time of the interaction, capturing a high-resolution screenshot of the entire visible area. In an example, the precise location of the element associated with the entity's interaction may be identified within the screenshot, using information from the extracted snippet. Visual markers or annotations may be overlaid on the screenshot to highlight the interacted element, drawing attention to the specific area of interaction while maintaining overall context. Examples of annotation may include, but not limited to, colored outlines, semi-transparent highlights, arrows, and labeled markers. The annotated screenshot may also incorporate contextual information such as event type labels, timestamps, brief descriptions of the action performed, or custom tags. The visual representation may provide a clear, contextualized view of the user's interaction with the interactive platform.

At block 408, the method includes executing, in response to receiving the annotated screenshot and the snippet, a computational model capable of generating instrumentation data for the event. The instrumentation data may include one or more attributes associated with the event. In an example, a computational model, such as a Large Language Model (LLM), a computer vision model, or a combination of both, may be used to analyze the annotated screenshot and HTML snippet. The computational model may process the inputs, i.e., the annotated screenshot and snippet, to generate detailed instrumentation data about the event.

In an example, the instrumentation data produced by the computational model may include various attributes associated with the event, such as a name for the event (e.g., “clickPriorityP0” for clicking a priority label), a description of the event (e.g., “User clicked on the ‘P0’ priority label in the attributes section of an issue”), an identifier designed to recognize similar events in future sessions (e.g., JavaScript code to uniquely identify the interacted element). Additional attributes may include, but not limited to the type of interaction (click, hover, input, etc.), state of the element before and after the interaction, data associated with the element (e.g., text content of a button), position of the element on the page, and timing of the event within the overall session. The computational model may analyze both the visual information from the annotated screenshot and the structural information from the snippet to generate the comprehensive set of attributes.

At block 410, the method includes causing storage of the instrumentation data in a database for rendering a subsequent assessment request for the event. This step involves saving the generated instrumentation data, which includes attributes such as the event name, description, and identifier, into a database system. The instrumentation data may be stored to create a repository of pre-processed and analyzed events that can be quickly accessed and utilized when processing future or subsequent events. When a new session replay file is processed, the system can first check this database to determine if it contains instrumentation data for similar events. If a match is found based on comparative analysis, the system can reuse the existing instrumentation data instead of generating new instrumentation data. This approach allows for efficient handling of subsequent assessment requests for the same or similar events, as the system can retrieve and apply previously generated instrumentation data rather than repeating the entire analysis process.

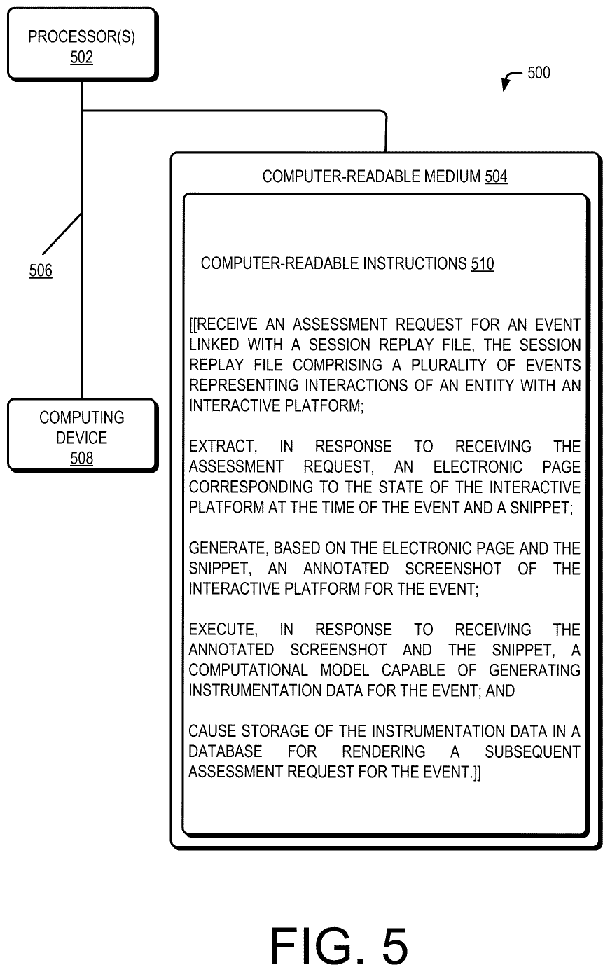

FIG. 5 illustrates a non-transitory computer-readable medium for management of entity activity in an interactive platform, according to an example implementation of the present subject matter., in accordance with an example of the present subject matter.

In an example, the computing environment 500 comprises processor(s) 502 communicatively coupled to a non-transitory computer-readable medium 504 through communication link 506. In an example, the computing environment 500 may be, for example, the system 102, 200. In an example, the processor(s) 502 may have one or more processing resources for fetching and executing computer-readable instructions 510 from the non-transitory computer-readable medium 504. The processor(s) 502 and the non-transitory computer-readable medium 504 may be implemented, for example, in the system 102, 200.

The non-transitory computer-readable medium 504 may be, for example, an internal memory device or an external memory. In an example, the communication link 506 may be a network communication link, or other communication links, such as a PCI (Peripheral component interconnect) Express, USB-C (Universal Serial Bus Type-C) interfaces, I2C (Inter-Integrated Circuit) interfaces, etc. In an example, the non-transitory computer-readable medium 504 comprises a set of computer-readable instructions 510 which may be accessed by the processor(s) 502 through the communication link 506 and subsequently executed for facilitating optimization of cellular network performance of the network element. The processor(s) 502 and the non-transitory computer-readable medium 504 may also be communicatively coupled to a system 102, 200 over the network. The processor(s) 502 and the non-transitory computer-readable medium 504 may also be communicatively coupled to a computing device 508 through the communication link 506.

Referring to FIG. 5, in an example, the non-transitory computer-readable medium 504 comprises computer-readable instructions 510 that cause the processor(s) 502 to receive a request to assess an event from a session replay file. The session replay file includes multiple events representing user interactions with an interactive platform. The event may be assessed to interpret the user interactions

In an example, the computer-readable instructions 510 may then cause the processor(s) 502 to extract, in response to the assessment request, two pieces of information-an electronic page showing the state of the interactive platform at the time of the event and a snippet of the electronic page focused on the element the user has interacted with.

In an example, the computer-readable instructions 510 may then cause the processor(s) 502 to generate an annotated screenshot using the extracted electronic page and snippet. The annotated screenshot may highlight the specific element the user interacted with within the context of the full electronic page. The annotated screenshot and snippet may then be used as an input into a computational model. The computation model may be executed to generate instrumentation data for the event. The instrumentation data includes various attributes associated with the event. The generated instrumentation data may be stored in a database to handle future assessment requests for similar events more efficiently.

Although examples of the present subject matter have been described in language specific to methods and/or structural features, it is to be understood that the present subject matter is not limited to the specific methods or features described. Rather, the methods and specific features are disclosed and explained as examples of the present subject matter.

What is claimed is:

1. A system comprising:
a processor to:
receive an assessment request for an event linked with a session replay file, the session replay file comprising a plurality of events representing interactions of an entity with an interactive platform, and wherein the assessment request is for interpreting the interactions of the entity with the interactive platform;
extract, in response to receiving the assessment request, an electronic page corresponding to a state of the interactive platform at a time of the event and a snippet of the electronic page surrounding an element associated with the interaction of the entity;
generate, based on the electronic page and the snippet, an annotated screenshot of the interactive platform for the event, wherein the annotated screenshot indicates the element associated with the interaction of the entity within the electronic page;
execute, in response to receiving the annotated screenshot and the snippet, a computational model capable of generating instrumentation data for the event, the instrumentation data indicative of one or more attributes associated with the event; and
cause storage of the instrumentation data in a database for rendering a subsequent assessment request for the event.

2. The system of claim 1, wherein for the subsequent assessment request, the processor is to:
receive a new event from a subsequent session replay file;
compare the new event with the one or more attributes associated with the event; and
ascertain, based on the comparison, whether to utilize the instrumentation data for the new event, wherein the instrumentation data is applied to the new event when the new event matches the instrumentation data associated with the event.

3. The system of claim 1, wherein for the subsequent assessment request, the processor is to:
receive a new event from a subsequent session replay file;
compute a similarity score by comparing the new event with the extracted snippet; and
ascertain, based on the similarity score, whether to utilize the instrumentation data for the new event, wherein the instrumentation data is applied to the new event when the similarity score exceeds a predetermined threshold value.

4. The system of claim 1, wherein one or more attributes comprises of a name of the event, a description of the event, and an identifier designed to identify similar events in the subsequent assessment request.

5. The system of claim 4, wherein the identifier is validated against the event that triggered its creation, wherein to validate the identifier the processor is to:
determine whether the identifier fails to correctly identify the element associated with the event; and
execute the computational model with the failed identifier and the snippet to generate a modified identifier, wherein the modified identifier correctly identifies the event.

6. The system of claim 1, wherein the processor is to:
identify a timestamp at which the interaction of the entity with the interactive platform occurs in the session replay file.

7. The system of claim 1, wherein to generate the annotated screenshot of the interactive platform for the event, the processor is to:
capture a screenshot of the electronic page;
identify a location of the element associated with the entity interaction within the screenshot;
overlay a visual marker on the screenshot to highlight the identified element; and
incorporate contextual annotations to the screenshot to provide additional information about the event.

8. The system of claim 1, wherein the processor is to:
analyze the instrumentation data generated for the plurality of events within the session replay file;
identify relationships between the plurality of events based on the analyzed instrumentation data;
generate an entity journey map based on the identified relationships; and
provide representations of the entity journey map.

9. A method comprising:
receiving an assessment request for an event linked with a session replay file, the session replay file comprising a plurality of events representing interactions of an entity with an interactive platform, and wherein the assessment request is for interpreting the interactions of the entity with the interactive platform;
extracting, in response to receiving the assessment request, an electronic page corresponding to a state of the interactive platform at a time of the event and a snippet of the electronic page surrounding an element associated with the interaction of the entity;
generating, based on the electronic page and the snippet, an annotated screenshot of the interactive platform for the event, wherein the annotated screenshot indicates the element associated with the interaction of the entity within the electronic page;
executing, in response to receiving the annotated screenshot and the snippet, a computational model capable of generating instrumentation data for the event, the instrumentation data indicative of one or more attributes associated with the event; and
causing storage of the instrumentation data in a database for rendering a subsequent assessment request for the event.

10. The method of claim 9, wherein for the subsequent assessment request, the method comprising:
receiving a new event from a subsequent session replay file;
comparing the new event with the one or more attributes associated with the event; and
ascertaining, based on the comparison, whether to utilize the instrumentation data for the new event, wherein the instrumentation data is applied to the new event when the new event matches the instrumentation data associated with the event.

11. The method of claim 9, wherein for the subsequent assessment request, the method comprising:
receiving a new event from a subsequent session replay file;
computing a similarity score by comparing the new event with the extracted snippet; and
ascertaining, based on the similarity score, whether to utilize the instrumentation data for the new event, wherein the instrumentation data is applied to the new event when the similarity score exceeds a predetermined threshold value.

12. The method of claim 9, wherein one or more attributes comprises of a name of the event, a description of the event, and an identifier designed to identify similar events in the subsequent assessment request.

13. The method of claim 12, wherein the identifier is validated against the event that triggered its creation, wherein to validate the identifier, the method comprising:
determining whether the identifier fails to correctly identify the element associated with the event; and
executing the computational model with the failed identifier and the snippet to generate a modified identifier, wherein the modified identifier correctly identifies the event.

14. The method of claim 9, wherein the method comprising:
identifying a timestamp at which the interaction of the entity with the interactive platform occurs in the session replay file.

15. The method of claim 9, wherein to generate the annotated screenshot of the interactive platform for the event, the method comprising:
capturing a screenshot of the electronic page;
identifying a location of the element associated with the entity interaction within the screenshot;
overlaying a visual marker on the screenshot to highlight the identified element; and
incorporating contextual annotations to the screenshot to provide additional information about the event.

16. The method of claim 9, wherein the method comprising:
analyzing the instrumentation data generated for the plurality of events within the session replay file;
identifying relationships between the plurality of events based on the analyzed instrumentation data;
generating an entity journey map based on the identified relationships; and
providing representations of the entity journey map.

17. A non-transitory computer-readable medium comprising instructions, the instructions being executable by a processor to:
receive an assessment request for an event linked with a session replay file, the session replay file comprising a plurality of events representing interactions of an entity with an interactive platform, and wherein the assessment request is for interpreting the interactions of the entity with the interactive platform;
extract, in response to receiving the assessment request, an electronic page corresponding to a state of the interactive platform at a time of the event and a snippet of the electronic page surrounding an element associated with the interaction of the entity;
generate, based on the electronic page and the snippet, an annotated screenshot of the interactive platform for the event, wherein the annotated screenshot indicates the element associated with the interaction of the entity within the electronic page;
execute, in response to receiving the annotated screenshot and the snippet, a computational model capable of generating instrumentation data for the event, the instrumentation data indicative of one or more attributes associated with the event; and
cause storage of the instrumentation data in a database for rendering a subsequent assessment request for the event.

18. The non-transitory computer-readable medium of claim 17, wherein for the subsequent assessment request, the instructions being executable by the processor to:
receive a new event from a subsequent session replay file;
compare the new event with the one or more attributes associated with the event; and
ascertain, based on the comparison, whether to utilize the instrumentation data for the new event, wherein the instrumentation data is applied to the new event when the new event matches the instrumentation data associated with the event.

19. The non-transitory computer-readable medium of claim 17, wherein for the subsequent assessment request, the instructions being executable by the processor to:
receive a new event from a subsequent session replay file;
compute a similarity score by comparing the new event with the extracted snippet; and
ascertain, based on the similarity score, whether to utilize the instrumentation data for the new event, wherein the instrumentation data is applied to the new event when the similarity score exceeds a predetermined threshold value.

20. The non-transitory computer-readable medium of claim 17, wherein one or more attributes comprises of a name of the event, a description of the event, and an identifier designed to identify similar events in the subsequent assessment request; wherein the identifier is validated against the event that triggered its creation, and wherein to validate the identifier, the instructions being executable by the processor to:
determine whether the identifier fails to correctly identify the element associated with the event; and
execute the computational model with the failed identifier and the snippet to generate a modified identifier, wherein the modified identifier correctly identifies the event.
